(19) United States
(12) Patent Application Publication
(10) Pub. No.: US 2023/0390985 A1
(43) Pub. Date: Dec. 7, 2023

(54) DATA CREATION DEVICE AND DATA CREATION SYSTEM

(71) Applicant: FANUC CORPORATION, Yamanashi (JP)

(72) Inventor: Yuusuke IMAI, Yamanashi-ken (JP)

(21) Appl. No.: 18/246,387

(22) PCT Filed: Sep. 24, 2021
(86) PCT No.: PCT/JP2021/034929

§ 371 Date: Mar. 23, 2023

(30) Foreign Application Priority Data
Sep. 30, 2020 (JP) 2020-164626

(51) Int. Cl. B29C 45/76

(52) U.S. Cl. CPC B29C 45/76; B29C 2945/76939

(57) ABSTRACT

This data creation device includes: a storage unit which stores a molding condition file including data on molding conditions (molding condition data) set in an injection molding machine; and a data creation unit which creates, on the basis of the molding condition file stored in the storage unit, image data of a molding condition screen when the molding conditions are displayed on a display of the injection molding machine, and index data indicating the contents of the molding conditions represented by the image data.

### TECHNICAL FIELD

The present invention relates to a data creation device for creating image data and a data creation system including the data creation device.

### BACKGROUND ART

An operator of an injection molding machine sets molding conditions by inputting numerical data or the like to the injection molding machine. JP 2019-077075 A discloses a display control device for displaying molding conditions set in the past on a display of an injection molding machine.

### SUMMARY OF THE INVENTION

There is a demand for displaying molding conditions of an injection molding machine on a terminal device such as a personal computer, a mobile terminal, or the like. In order to realize functions of the display control device disclosed in JP 2019-077075 A by using various terminal devices, special software is required for each of the operating systems (OS) of the terminal devices. The software uses molding condition data to display the same display screen as the display screen displayed on the display of the injection molding machine on the display of the terminal device. In order to install such special software in each terminal device, a large number of man-hours and costs are required.

Therefore, an object of the present invention is to provide a data creation device and a data creation system that allow molding conditions of an injection molding machine to be easily displayed on various terminal devices.

According to a first aspect of the present invention, there is provided a data creation device including: a storage unit configured to store a molding condition file including data of a molding condition set in an injection molding machine; and a data creation unit configured to create, based on the molding condition file stored in the storage unit, image data of a molding condition screen used when the molding condition is displayed on a display of the injection molding machine and index data indicating a content of the molding condition represented by the image data.

According to a second aspect of the present invention, there is provided a data creation system including: the data creation device of the first aspect; and a display device, wherein the display device includes: a second display different from the display of the injection molding machine; and a display control unit configured to cause the index data and the image data to be displayed on the second display, and wherein the display control unit causes the image data corresponding to the index data to be displayed, the index data being selected, by an operator operating an operation unit, from among the index data displayed on the second display.

According to a third aspect of the present invention, there is provided a data creation system including a control device of an injection molding machine and a management device communicably connected to the control device, the data creation system further including: a storage unit configured to store a molding condition file including data of a molding condition set in the injection molding machine; and a data creation unit configured to create, based on the molding condition file stored in the storage unit, image data of a molding condition screen used when the molding condition is displayed on a display of the injection molding machine and index data indicating a content of the molding condition represented by the image data.

According to the present invention, the molding conditions of the injection molding machine can be easily displayed by various terminal devices.

### BRIEF DESCRIPTION OF DRAWINGS

FIG. 1 is a diagram illustrating functional blocks of the data creation device according to the present embodiment;

FIG. 2 is a diagram showing a configuration of a molding condition file;

FIG. 3 is a diagram illustrating a screen displayed by a display control unit, based on an image data group and an index data group;

FIG. 4 is a diagram showing a configuration of an injection molding machine having a data creation device;

FIG. 5 is a diagram showing a configuration of an injection molding system;

FIG. 6 is a diagram illustrating a configuration of a management device including a data creation device;

FIG. 7 is a diagram illustrating an example of a configuration of a data creation system;

FIG. 8 is a flowchart illustrating a processing flow of a data creation process; and

FIG. 9 is a flowchart illustrating a processing flow of screen display process.

### DETAILED DESCRIPTION OF THE INVENTION

A preferred embodiment of a data creation device and a data creation system according to the present invention will be described in detail below with reference to the accompanying drawings.

### 1. Configuration of Data Creation Device 10

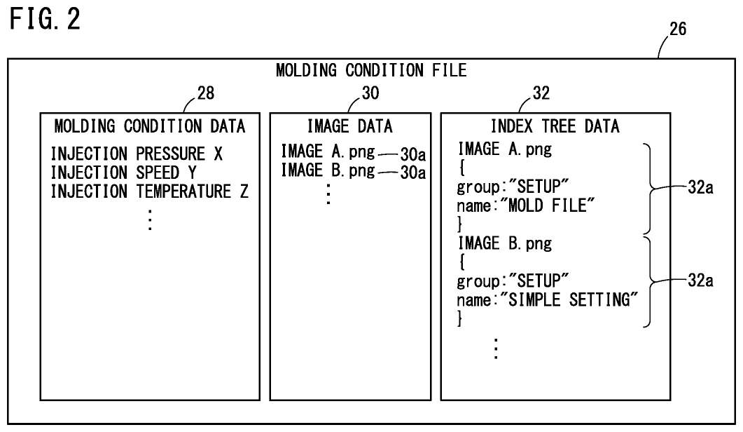

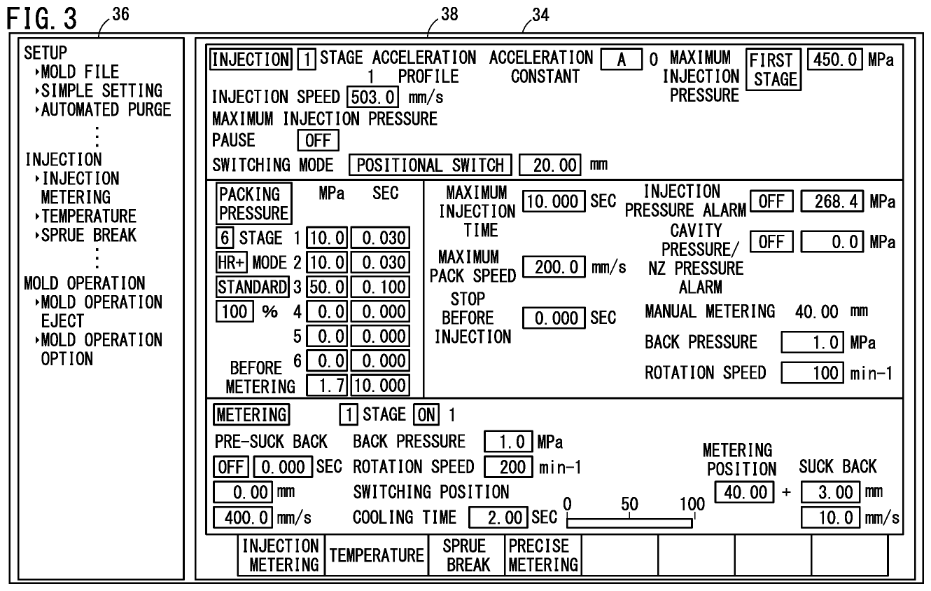

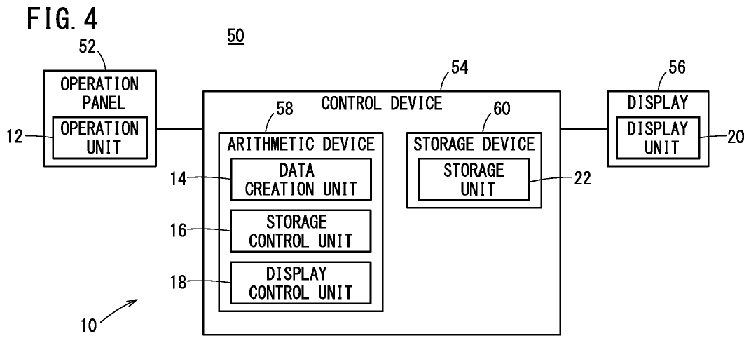

In general, when operating an injection molding machine 50 (FIG. 4), the operator causes a display 56 (FIG. 4) of the injection molding machine 50 to display molding conditions in a predetermined layout. The molding conditions refer to numerical data and character data necessary for performing a molding operation, such as injection pressure, injection speed, injection temperature, and the like. The data creation device 10 described below creates image data 30a (FIG. 2) of a molding condition screen 38 (FIG. 3) in which molding conditions are written. The image data 30a can be displayed not only by the display 56 of the injection molding machine 50 but also by various devices.

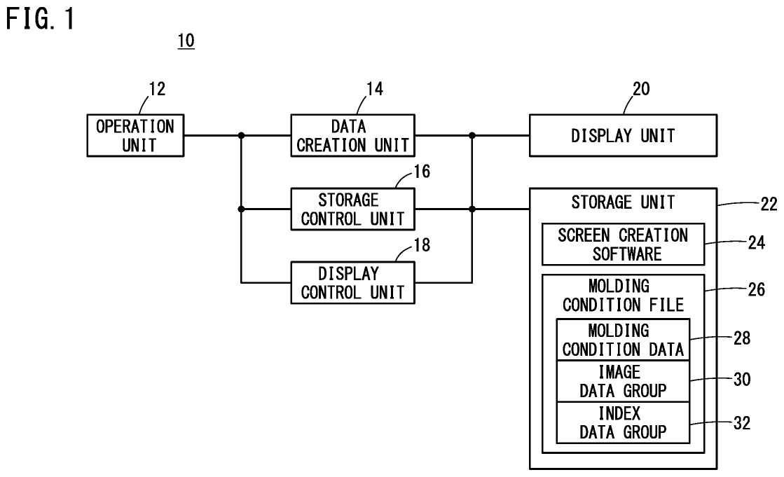

FIG. 1 shows functional blocks of the data creation device 10 according to the present embodiment. The data creation device 10 includes an operation unit 12, a data creation unit 14, a storage control unit 16, a display control unit 18, a display unit 20, and a storage unit 22.

The operation unit 12 outputs a signal corresponding to an operation performed by the operator to the data creation unit 14 and the storage control unit 16. The data creation unit 14 creates an image data group 30 and an index data group 32 based on a molding condition file 26 stored in the storage unit 22. The image data group 30 and the index data group 32 correspond to a plurality of molding condition screens 38. The storage control unit 16 causes the storage unit 22 to store a plurality of image data 30a (FIG. 2) included in the image data group 30 and a plurality of index data 32a (FIG. 2) included in the index data group 32 in association with each other. The display control unit 18 causes the display unit 20 to display various screens. For example, the display control unit 18 causes the display unit 20 to display a tree-view screen 36 and a molding condition screen 38 illustrated in FIG. 3. The display unit 20 displays various screens in addition to the tree-view screen 36 and the molding condition screen 38.

The storage unit 22 stores screen creation software 24 and molding condition files 26. The screen creation software 24 is software for creating the same screen as the display screen for the molding conditions displayed on the display 56 of the injection molding machine 50. The screen creation software 24 may be the same as software used in the injection molding machine 50. Normally, since the molding conditions include a wide variety of setting items, a plurality of display screens are used for displaying the molding conditions. Therefore, the screen creation software 24 is configured to create a plurality of display screens for each molding condition.

FIG. 2 shows the configuration of the molding condition file 26. The molding condition file 26 is created for each product to be molded, for each mold to be used, or for each injection molding machine 50. The molding condition file 26 includes molding condition data 28. As shown in FIG. 2, the molding condition file 26 may include the image data group 30 created by the data creation device 10. The molding condition file 26 may include the index data group 32 created by the data creation device 10. Thus, the image data 30a and the index data 32a are associated with each other. Hereinafter, the molding condition file 26 in which the image data 30a and the index data 32a are associated with each other will be described.

The molding condition data 28 is data including numerical data of the molding conditions, character data of the molding conditions, and the like. The molding condition data 28 is created by an operator setting the molding conditions in the injection molding machine 50. Each data included in the molding condition data 28 is associated with information (a screen name and a group name) of a display screen to be used at the time of setting the data.

The image data group 30 includes a plurality of image data 30a. The image data 30a is image data of one molding condition screen 38 in which numerical data of the molding conditions and character data of the molding conditions are written on the display screen. As described above, a plurality of display screens are usually used to display the molding conditions. Since the molding condition screen 38 is created for each display screen, each molding condition file 26 includes a plurality of image data 30a corresponding respectively to a plurality of molding condition screens 38. Each image data 30a is stored in a format that can be displayed by a known viewer. For example, each image data 30a is stored in a JPG format, a PNG format, or the like.

The index data group 32 includes a plurality of index data 32a. The index data 32a is created for each image data 30a. Each index data 32a defines the screen name of the molding condition screen 38 displayed based on the image data 30a and the group name of the group to which the molding condition screen 38 belongs. The screen name is an index indicating the content of the molding conditions represented by the image data 30a. This index makes it possible to identify each image data 30a. The index data group 32 is described in a form displayed in a known data format. For example, the index data group 32 is described in a data description language such as xml, json, or the like.

In FIG. 2, an image data group 30 in PNG format and an index data group 32 described in json are illustrated. The index data 32a shown in FIG. 2 defines that the molding condition screen 38 displayed on the basis of the image data 30a of the screen A belongs to a group of “setup”. The index data 32a shown in FIG. 2 defines that the molding condition screen 38 displayed on the basis of the image data 30a of the screen A bears the screen name of “mold file”. Further, the index data 32a shown in FIG. 2 defines that the molding condition screen 38 displayed based on the image data 30a of the screen B belongs to the group of “setup”. The index data 32a shown in FIG. 2 defines that the molding condition screen 38 displayed on the basis of the image data 30a of the screen B bears the screen name of “simple setting”.

Of the data included in the molding condition file 26, the molding condition data 28 is created by the operator setting the molding conditions in the injection molding machine 50. On the other hand, the image data group 30 and the index data group 32 are created by the operator causing the data creation device 10 to execute a data creating process described in the following [3]. That is, the creation timing of the molding condition data 28 and the creation timing of the image data group 30 and the index data group 32 are not necessarily the same. For this reason, there are cases where the molding condition file 26 may include only the molding condition data 28 and not include the image data group 30 or the index data group 32. In these cases, the image data group 30 and the index data group 32 are stored in the molding condition file 26 later. The image data group 30 and the index data group 32 may be stored in separate files.

As described above, the molding condition file 26 is created for each product, each mold, and each injection molding machine 50. That is, a plurality of types of molding condition files 26 are created from past to present. The storage unit 22 stores at least one of a molding condition file 26 including molding condition data 28 currently set in one or more injection molding machines 50 or a molding condition file 26 including molding condition data 28 previously set in one or more injection molding machines 50.

FIG. 3 shows a screen displayed by the display control unit 18 based on the image data group 30 and the index data group 32. The tree-view screen 36 and the molding condition screen 38 are displayed adjacent to each other in the same display area 34.

The tree-view screen 36 is displayed on the left side in the display area 34. The tree-view screen 36 is a screen displayed based on the index data group 32. In the tree-view screen 36, a tree in which screen names (mold file, injection metering, . . . ) are classified by group names (setup, injection, . . . ) is displayed. In a state where the tree-view screen 36 is displayed, the operator operates the operation unit 12, whereby one of the screen names can be selected. In response to the selection by the operator, the molding condition screen 38 corresponding to the selected screen name is displayed in the display area 34.

The molding condition screen 38 is displayed on the right side in the display area 34. The molding condition screen 38 is a screen displayed based on one of the image data 30a. The image data 30a is in a JPG format, a PNG format, or the like. Therefore, the molding condition data 28 cannot be changed or deleted in the molding condition screen 38.

The image data 30a is stored in a format that can be displayed by a known viewer, such as a JPG format or a PNG format. According to the present embodiment, the molding condition file 26 is converted into an image format that can be displayed by a known viewer. According to the present embodiment, the molding condition file 26 is converted into a known format. Therefore, the molding conditions of the injection molding machine 50 can be easily displayed by various terminal devices.

### 2. Device Including Data Creation Device 10 and System Including Data Creation Device 10

The data creation device 10 according to the present embodiment may be provided in one independent device. The data creation device 10 according to the present embodiment may be provided across a plurality of devices. Hereinafter, a specific device including the data creation device 10 and a system including the data creation device 10 will be exemplified. In first to third examples described below, the same components as those of the embodiment described above are denoted by the same reference numerals. In each example, the same components are denoted by the same reference numerals.

### 2-1. First Example

The data creation device 10 may be provided in the injection molding machine 50. As a first example, the injection molding machine 50 including the data creation device 10 will be described.

FIG. 4 shows a configuration of an injection molding machine 50 including the data creation device 10. The injection molding machine 50 includes an operation panel 52, a control device 54, and a display 56. The injection molding machine 50 includes an injection device (not shown) and a mold clamping device (not shown).

The operation panel 52 includes at least one of a touch panel or an operation switch. The operation panel 52 functions as the operation unit 12. The control device 54 is a CNC device that controls the operation of the injection device based on the molding conditions and controls the operation of the mold clamping device based on the molding conditions. The control device 54 includes an arithmetic device 58 and a storage device 60. The arithmetic device 58 includes a processor such as a CPU (central processing unit). The arithmetic device 58 functions as the data creation unit 14, the storage control unit 16, and the display control unit 18 by executing a program stored in the storage device 60. The storage device 60 includes, for example, a RAM, a ROM, and the like. The storage device 60 functions as the storage unit 22. The display 56 is, for example, a liquid crystal display. The display 56 functions as the display unit 20.

### 2-2. Second Example

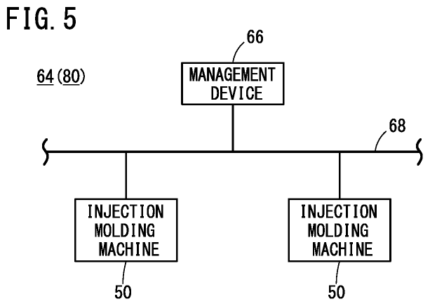

FIG. 5 illustrates a configuration of an injection molding system 64. The injection molding system 64 includes a plurality of injection molding machines 50, a management device 66, and a network 68. Each of the plurality of injection molding machines 50 and the management device 66 are communicably connected to each other via the network 68. The network 68 is a LAN. The network 68 may be the Internet.

In the injection molding system 64, the data creation device 10 may be provided in the management device 66. As a second example, the management device 66 including the data creation device 10 will be described.

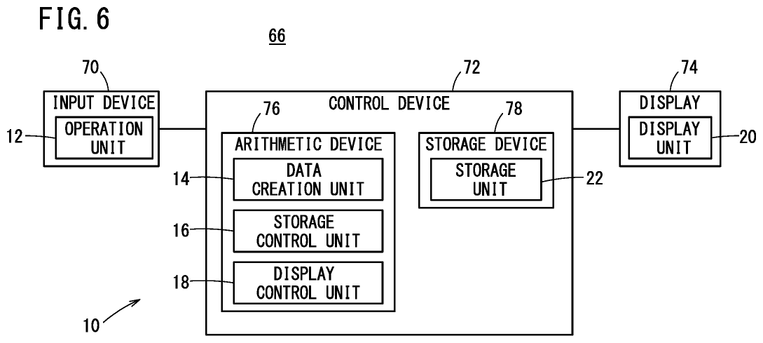

FIG. 6 shows a configuration of the management device 66 having the data creation device 10. The management device 66 aggregates and manages each data (including the molding condition data 28) of each injection molding machine 50. The management device 66 includes an input device 70, a control device 72, and a display 74 (a second display). The management device 66 is, for example, a personal computer. The management device 66 may be a server. The management device 66 may be formed by cloud computing.

The input device 70 includes a keyboard and a mouse. The input device 70 functions as the operation unit 12. The control device 72 includes an arithmetic device 76 and a storage device 78. The arithmetic device 76 includes a processor such as a CPU. The arithmetic device 76 functions as the data creation unit 14, the storage control unit 16, and the display control unit 18 by executing a program stored in the storage device 78. The storage device 78 includes, for example, a RAM, a ROM, and the like. The storage device 78 functions as the storage unit 22. The display 74 is, for example, a liquid crystal display. The display 74 functions as the display unit 20.

### 2-3. Third Example

In the present specification, the injection molding system 64 in which the data creation device 10 is provided is also referred to as a data creation system 80. That is, the injection molding machine 50 of the first example and the injection molding system 64 including the management device 66 of the second example can also be called the data creation system 80.

In the data creation system 80, the plurality of functional units of the data creation device 10 may be provided across a plurality of devices connected to the network 68. That is, in the data creation system 80, the operation unit 12, the data creation unit 14, the storage control unit 16, the display control unit 18, the display unit 20, and the storage unit 22 may be provided across a plurality of devices connected to the network 68.

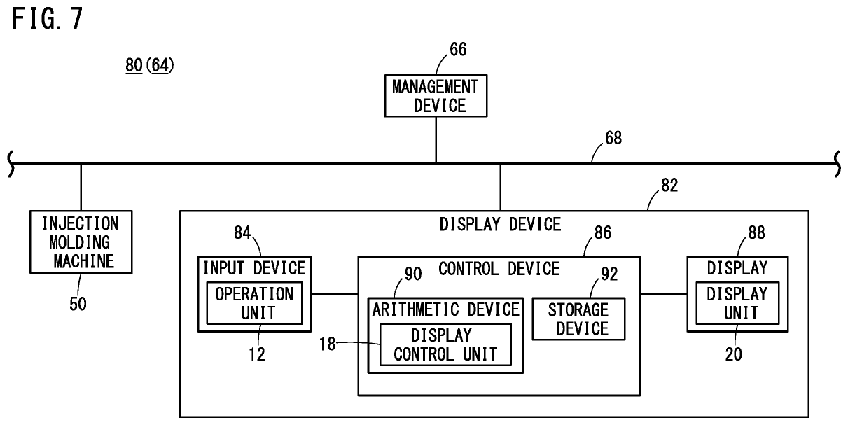

FIG. 7 shows an example of a configuration of the data creation system 80. In the data creation system 80 of the third example, a plurality of injection molding machines 50, a management device 66, and a display device 82 are connected to a network 68. Each of the plurality of injection molding machines 50, the management device 66, and the display device 82 can communicate with each other via the network 68.

The display device 82 includes an input device 84, a control device 86, and a display (a second display) 88. The display device 82 is, for example, a personal computer or a mobile terminal. The display device 82, each of the plurality of injection molding machines 50, and the management device 66 are communicably connected to each other via the network 68.

The input device 84 includes a keyboard, a mouse, a touch panel, and the like. The input device 84 functions as the operation unit 12 which is used in the screen display process (see [4] below). The control device 86 includes an arithmetic device 90 and a storage device 92. The arithmetic device 90 includes a processor such as a CPU. The arithmetic device 90 functions as the display control unit 18 by executing a program stored in the storage device 92. The storage device 92 includes, for example, a RAM, a ROM, and the like. The display 88 is, for example, a liquid crystal display. The display 88 functions as the display unit 20 which is used in the screen display process (see [4] below). The storage device 60 (FIG. 4) of the injection molding machine 50 or the storage device 78 (FIG. 6) of the management device 66 functions as the storage unit 22.

The control device 86 (display control unit 18) receives the molding condition file 26 from the storage device 78 of the management device 66. The control device 86 (display control unit 18) causes the display 88 (display unit 20) to display the tree-view screen 36 in accordance with an operation performed through the input device 84 (operation unit 12), and further causes the display 88 (display unit 20) to display the molding condition screen 38.

### 3. Data Creation Process

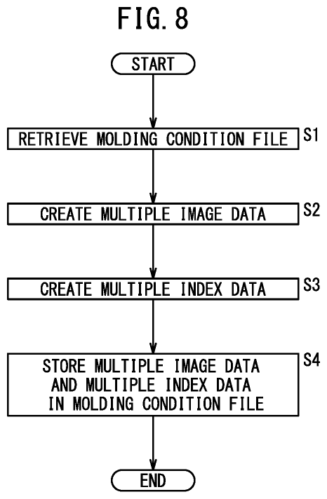

FIG. 8 is a flowchart illustrating a processing flow of a data creation process. Referring to FIG. 8, the process of creating the image data 30a based on the molding condition file 26 will be described. This process is referred to as the data creation process. The data creation process is started when an operator performs a predetermined operation using the operation unit 12. For example, the operator uses the operation unit 12 to select a molding condition file 26 for creating a desired image data group 30, from among one or more molding condition files 26 stored in the storage unit 22. Thereafter, the operator performs a start operation for the data creation process using the operation unit 12.

In step S1, the data creation unit 14 retrieves the molding condition file 26 selected by the operator, from the storage unit 22. At this stage, the selected molding condition file 26 includes the molding condition data 28. On the other hand, the selected molding condition file 26 does not include the image data group 30 and the index data group 32. When step S1 is completed, the process proceeds to step S2.

In step S2, the data creation unit 14 creates a plurality of image data 30a based on the molding condition data 28 included in the retrieved molding condition file 26. Here, the data creation unit 14 uses the screen creation software 24 to write the molding condition data 28 of the molding condition file 26 on each of the display screens for the molding conditions. As a result, the data creation unit 14 creates a plurality of image data 30a corresponding to the plurality of molding condition screens 38. When step S2 is completed, the process proceeds to step S3.

In step S3, the data creation unit 14 creates a plurality of index data 32a. The data creation unit 14 refers to information (screen name and group name) of the display screen included in the molding condition data 28. The data creation unit 14 associates the group name and the screen name with each of the created image data 30a to create a plurality of index data 32a. When step S3 is completed, the process proceeds to step S4.

In step S4, the storage control unit 16 stores the plurality of created image data 30a and the plurality of created index data 32a, in the molding condition file 26. The molding condition file 26 shown in FIG. 2 is created by the above processing. When step S4 is completed, the data creation process is put to an end.

### 4. Screen Display Process

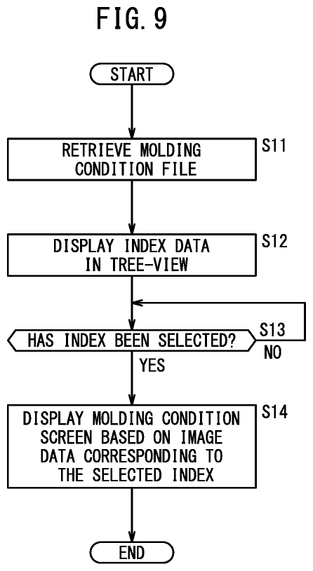

FIG. 9 is a flowchart illustrating a processing flow of screen display process. A process of displaying the molding condition screen 38 based on the molding condition file 26 will be described with reference to FIG. 9. This process is referred to as the screen display process. The screen display process is started when the operator performs a predetermined operation using the operation unit 12. For example, the operator uses the operation unit 12 to select a molding condition file 26 for displaying a desired molding condition screen 38, from among one or more molding condition files 26 stored in the storage unit 22. Thereafter, the operator performs a start operation for the screen display process using the operation unit 12.

In step S11, the display control unit 18 retrieves the molding condition file 26 selected by the operator, from the storage unit 22. When step S11 is completed, the process proceeds to step S12.

In step S12, the display control unit 18 displays the tree-view screen 36 within the display area 34 of the display unit 20, based on the index data group 32 of the molding condition file 26. In the tree-view screen 36, each index is displayed in a tree view. In step S12, the display control unit 18 uses a browser having a viewer function of the index data group 32. When step S12 is completed, the process proceeds to step S13.

In step S13, the display control unit 18 determines whether or not a screen name (index) has been selected. The operator can select one screen name (index) from among the screen names (indices) displayed on the tree-view screen 36, by operating the operation unit 12. When the screen name (index) has been selected (step S13: YES), the process proceeds to step S14. On the other hand, when the screen name (index) is not selected (step S13: NO), the determination in step S13 is continuously executed.

In step S14, the display control unit 18 causes the display unit 20 to display the molding condition screen 38, based on the image data 30a corresponding to the selected screen name (index). In Step S14, the display control unit 18 uses a browser having a viewer function of the image data 30a. Further, the display control unit 18 changes a display form (for example, a color or the like) of the selected screen name (index) on the tree-view screen 36.

By the above processing, the tree-view screen 36 and the molding condition screen 38 are displayed in the display area 34 of the display unit 20. Further, when the operator has selected another screen name (index), the molding condition screen 38 displayed in the display area 34 of the display unit 20 transitions from the initial screen to another screen.

### 5. Invention Obtained from Embodiments

The invention graspable from the embodiments described above will be described below.

A first aspect of the present invention is characterized by the data creation device including: the storage unit (22) configured to store the molding condition file (26) including the data (28) of the molding condition set in the injection molding machine (50); and the data creation unit (14) configured to create, based on the molding condition file stored in the storage unit, the image data (30a) of the molding condition screen (38) used when the molding condition is displayed on the display (56) of the injection molding machine and the index data (32a) indicating the content of the molding condition represented by the image data.

In the first aspect, the storage unit may store at least one of the molding condition file including the data of the molding condition currently set in the injection molding machine or the molding condition file including the data of the molding condition previously set in the injection molding machine.

The first aspect may further include the storage control unit (16) configured to cause the storage unit to store the image data and the index data created by the data creation unit, in association with each other.

In the first aspect, the storage control unit may store the image data and the index data created by the data creation unit, in the molding condition file.

In the first aspect, the index data may be the screen name of the molding condition screen.

In the first aspect, the data creation unit may create the image data of the molding condition screen in which the molding condition is written on the display screen displayed on the display when the molding condition is to be set.

In the first aspect, the data creation unit may create the plurality of image data of molding condition screens used when the molding condition is displayed on the display and the plurality of index data indicating the content of the molding condition represented by the plurality of image data, based on the molding condition file stored in the storage unit.

In the first aspect, the data creation unit and the storage unit may be provided in the control device (54) of the injection molding machine.

In the first aspect, the display control unit (18) may be further provided that causes the index data and the image data to be displayed on the display of the injection molding machine, and the display control unit may cause the image data corresponding to the index data to be displayed, the index data being selected, by an operator operating an operation unit (12), from among the index data displayed on the display.

In the first aspect, the data creation unit and the storage unit may be provided in the management device (66) that manages the plurality of injection molding machines.

In the first aspect, the data creation device may further include: the second display (74) different from the display of the injection molding machine; and the display control unit (18) configured to cause the index data and the image data to be displayed on the second display, and the display control unit may cause the image data corresponding to the index data to be displayed, the index data being selected, by an operator operating the operation unit, from among the index data displayed on the second display.

A second aspect of the present invention is characterized by the data creation system (80) including: the data creation device (10) of the first aspect; and the display device (82), wherein the display device includes: the second display (88) different from the display (56) of the injection molding machine; and the display control unit (18) configured to cause the index data (32a) and the image data (30a) to be displayed on the second display, and wherein the display control unit causes the image data corresponding to the index data to be displayed, the index data being selected, by an operator operating the operation unit (12), from among the index data displayed on the second display.

A third aspect of the present invention is characterized by the data creation system (80) including the control device (54) of the injection molding machine (50) and the management device (66) communicably connected to the control device, the data creation system further including: the storage unit (22) configured to store the molding condition file (26) including the data (28) of the molding condition set in the injection molding machine; and the data creation unit (14) configured to create, based on the molding condition file stored in the storage unit, the image data (30a) of the molding condition screen (38) used when the molding condition is displayed on the display (56) of the injection molding machine and the index data (32a) indicating the content of the molding condition represented by the image data.

The third aspect may further include the storage control unit (16) configured to cause the storage unit to store the image data and the index data created by the data creation unit, in association with each other.

In the third aspect, the storage unit may be provided in the control device or the management device, and the data creation unit may be provided in the control device or the management device.

The image data 30a created in the first to third aspects can be displayed by using a browser or the like having a function of a generally used viewer. Therefore, according to the first to third aspects, the molding conditions of the injection molding machine 50 can be easily displayed by various terminal devices.

The configuration of the data creation device and the data creation system according to the present invention is not limited to those of the embodiments described above but can adopt various configurations without departing from the essence and gist of the present invention.

1. A data creation device comprising:
a storage unit configured to store a molding condition file including data of a molding condition set in an injection molding machine; and
a data creation unit configured to create, based on the molding condition file stored in the storage unit, image data of a molding condition screen used when the molding condition is displayed on a display of the injection molding machine and index data indicating a content of the molding condition represented by the image data.

2. The data creation device according to claim 1, wherein
the molding condition file comprises a plurality of molding condition files, and the storage unit stores at least one of the molding condition file including the data of the molding condition currently set in the injection molding machine or the molding condition file including the data of the molding condition previously set in the injection molding machine.

3. The data creation device according to claim 1, further comprising:
a storage control unit configured to cause the storage unit to store the image data and the index data created by the data creation unit, in association with each other.

4. The data creation device according to claim 3, wherein
the storage control unit stores the image data and the index data created by the data creation unit, in the molding condition file.

5. The data creation device according to claim 1, wherein
the index data is a screen name of the molding condition screen.

6. The data creation device according to claim 1, wherein
the data creation unit creates the image data of the molding condition screen in which the molding condition is written on a display screen displayed on the display when the molding condition is to be set.

7. The data creation device according to claim 1, wherein
the image data of the molding condition screen comprises a plurality of image data of molding condition screens, the index data comprises a plurality of index data, and the data creation unit creates the plurality of image data of molding condition screens used when the molding condition is displayed on the display and the plurality of index data indicating the content of the molding condition represented by the plurality of image data, based on the molding condition file stored in the storage unit.

8. The data creation device according to claim 1, wherein
the data creation unit and the storage unit are provided in a control device of the injection molding machine.

9. The data creation device according to claim 8, further comprising:
a display control unit configured to cause the index data and the image data to be displayed on the display of the injection molding machine,
wherein the display control unit causes the image data corresponding to the index data to be displayed, the index data being selected, by an operator operating an operation unit, from among the index data displayed on the display.

10. The data creation device according to claim 1, wherein
the injection molding machine comprises a plurality of injection molding machines, and the data creation unit and the storage unit are provided in a management device configured to manage the plurality of injection molding machines.

11. The data creation device according to claim 10, further comprising:
a second display different from the display of the injection molding machine; and
a display control unit configured to cause the index data and the image data to be displayed on the second display,
wherein
the display control unit causes the image data corresponding to the index data to be displayed, the index data being selected, by an operator operating an operation unit, from among the index data displayed on the second display.

12. A data creation system comprising: the data creation device according to claim 1; and a display device, wherein
the display device includes:
a second display different from the display of the injection molding machine; and
a display control unit configured to cause the index data and the image data to be displayed on the second display,
and wherein
the display control unit causes the image data corresponding to the index data to be displayed, the index data being selected, by an operator operating an operation unit, from among the index data displayed on the second display.

13. A data creation system comprising a control device of an injection molding machine and a management device communicably connected to the control device, the data creation system further comprising:
a storage unit configured to store a molding condition file including data of a molding condition set in the injection molding machine; and
a data creation unit configured to create, based on the molding condition file stored in the storage unit, image data of a molding condition screen used when the molding condition is displayed on a display of the injection molding machine and index data indicating a content of the molding condition represented by the image data.

14. The data creation system according to claim 13, further comprising:
a storage control unit configured to cause the storage unit to store the image data and the index data created by the data creation unit, in association with each other.

15. The data creation system according to claim 13, wherein
the storage unit is provided in the control device or the management device, and
the data creation unit is provided in the control device or the management device.
